(19) United States
(12) Patent Application Publication
(10) Pub. No.: US 2024/0412075 A1
(43) Pub. Date: Dec. 12, 2024

(54) KERNEL-GUIDED ARCHITECTURE SEARCH AND KNOWLEDGE DISTILLATION

(71) Applicant: QUALCOMM Incorporated, San Diego, CA (US)

(72) Inventor: Haijun ZHAO, Beijing (CN)

(21) Appl. No.: 18/262,718

(22) PCT Filed: Mar. 15, 2021
(86) PCT No.: PCT/CN2021/080727

§ 371 Date: Jul. 24, 2023

(51) Int. Cl. G06N 3/096; G06N 3/045

(52) U.S. Cl. CPC G06N 3/096; G06N 3/045

(57) ABSTRACT

A method for compressing of a deep neural network model includes determining an architecture of a teacher model. An initial layer of the teacher model is preserved and included in a student model. Repeated layers of the teacher model having a same type are identified. The second of such layers is removed such that the student model includes fewer layers than the teacher model. Knowledge distillation is applied to train the student model. The identifying and removal of layers of the same type is repeated to compress the student model.

### BACKGROUND

### Field

Aspects of the present disclosure generally relate to deep neural network (DNN) knowledge distillation, and model compression.

### Background

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Artificial neural networks have grown in popularity because of their ability to solve complex problems. As such, it is desirable to incorporate such artificial neural networks on edge devices such as smart phones or other mobile communication devices. Unfortunately, the model size may be prohibitively large with millions of parameters.

### SUMMARY

In an aspect of the present disclosure, a method for compressing an artificial neural network is provided. The method includes determining an architecture of a teacher model. The method also includes preserving an initial layer of the teacher model. Additionally, the method includes identifying successive layers of the teacher model having a same type. The successive layers include a first layer and second layer. The method also includes removing the second layer of the successive layers to produce a student model. The student model has fewer layers than the teacher model. Further, the method includes applying knowledge distillation to train the student model.

In another aspect of the present disclosure, an apparatus for compressing an artificial neural network is provided. The apparatus includes a memory and one or more processors coupled to the memory. The processor(s) are configured to determine an architecture of a teacher model. The processor(s) are also configured to preserve initial layer of the teacher model. In addition, the processor(s) are configured to identify successive layers of the teacher model having a same type. The successive layers include a first layer and second layer. The processor(s) are also configured to remove the second layer of the successive layers to produce a student model. The student model has fewer layers than the teacher model. Further, the processor(s) are configured to apply knowledge distillation to train the student model.

In another aspect of the present disclosure, an apparatus for compressing an artificial neural network is provided. The apparatus includes means for determining an architecture of a teacher model. The apparatus also includes means for preserving an initial layer of the teacher model. Additionally, the apparatus includes means for identifying successive layers of the teacher model having a same type. The successive layers include a first layer and second layer. The apparatus also includes means for removing the second layer of the successive layers to produce a student model. The student model has fewer layers than the teacher model. Further, the apparatus includes means for applying knowledge distillation to train the student model.

In another aspect of the present disclosure, a non-transitory computer readable medium is provided. The computer readable medium has encoded thereon program code for compressing an artificial neural network. The program code is executed by a processor and includes code to determine an architecture of a teacher model. The program code also includes code to preserve initial layer of the teacher model. Additionally, the program code includes code to identify successive layers of the teacher model having a same type. The successive layers include a first layer and second layer. The program code also includes code to remove the second layer of the successive layers to produce a student model. The student model has fewer layers than the teacher model. Furthermore, the program code includes code to apply knowledge distillation to train the student model.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an example architecture for kernel guided student architecture search and reconfiguration, in accordance with aspects of the present disclosure.

FIGS. 5 and 6 are flow diagrams illustrating a method for generating a compressed neural network model, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Artificial neural networks have grown in popularity because of their ability to solve complex problems. As such, it is desirable to incorporate artificial neural networks on edge devices such as smart phones or other mobile communication devices. Unfortunately, the model size may be prohibitively large, with some models having millions of parameters.

One approach to reducing the model size is pruning. Neural network pruning involves setting low-valued parameters (e.g., weights) to zero, thereby reducing the computations performed. Neural network pruning has achieved comparable performance for large-sparse models. However, pruning based on sparsity for smaller/more dense models (e.g., fewer than one million parameters) results in poor model performance.

Knowledge distillation is a technique for compressing large neural network models to produce a smaller model. A larger trained model teaches a smaller model to operate to perform a given task. Knowledge distillation transfers knowledge from teacher (small/dense) models to a smaller student model. However, even with the same-level trainable parameters, student models with different architectures can achieve different generalization abilities. The configuration of a student architecture involves intensive network architecture engineering. Accordingly, aspects of the present disclosure are directed to knowledge distillation with search and reconfiguration of a student network for learning knowledge from a small teacher model. In some aspects, an optimal student model architecture may be determined by minimizing the accuracy loss and the number of trainable parameters. Additionally, in some aspects, model compression techniques such as quantization and pruning, for example, may be applied to further improve the student model architecture.

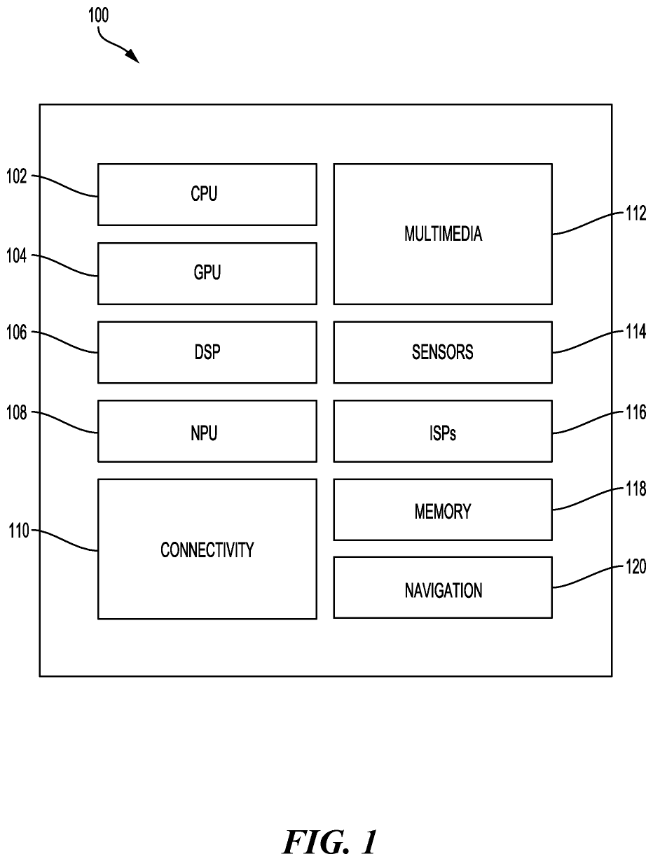

FIG. 1 illustrates an example implementation of a system-on-a-chip (SOC) 100, which may include a central processing unit (CPU) 102 or a multi-core CPU configured for guided student architecture search and knowledge distillation. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system. In one example, sensor processor 114 may be configured to process radio frequency signal or radar signals. For instance, the sensor processor 114 may be configured to receive millimeter wave (mmWave), frequency modulated continuous wave (FMCW), pulse-based radar, or the like.

The SOC 100 may be based on an ARM instruction set. In an aspect of the present disclosure, the instructions loaded into the general-purpose processor 102 may include code to determine an architecture of a teacher model. The general-purpose processor 102 may also include code to preserve an initial layer of the teacher model. The general-purpose processor 102 may also include code to identify successive layers of the teacher model having a same type. The successive layers include a first layer and second layer. The general-purpose processor 102 may further include code to remove the second layer of the successive layers to produce a student model. The student model has fewer layers than the teacher model. Furthermore, the general-purpose processor 102 includes code to apply knowledge distillation to train the student model.

In an aspect of the present disclosure, the instructions loaded into the general-purpose processor 102 may include code to generate an initial student model from a teacher model. The general-purpose processor 102 may also include code to remove a layer from the initial student model to generate an intermediate student model. The general-purpose processor 102 may also include code to provide an input to the teacher model and the intermediate student model. The general-purpose processor 102 may further include code to apply a model loss function to adjust a set of parameters of the intermediate student model. Furthermore, the general-purpose processor 102 includes code to output a final student model based on the intermediate student model.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

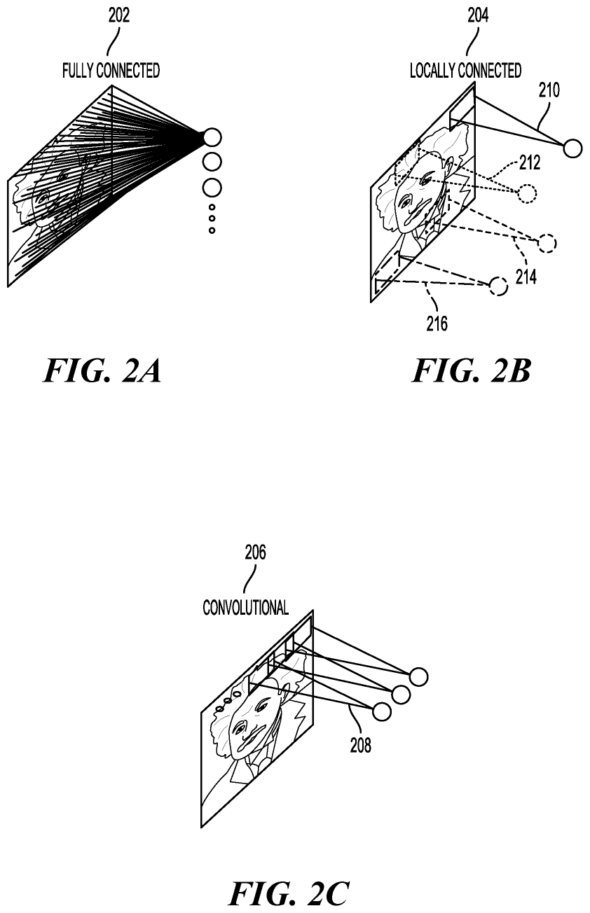

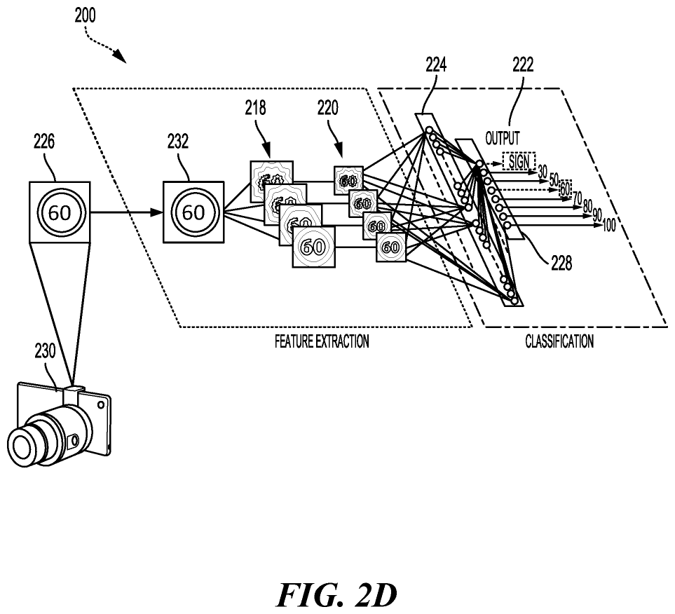

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

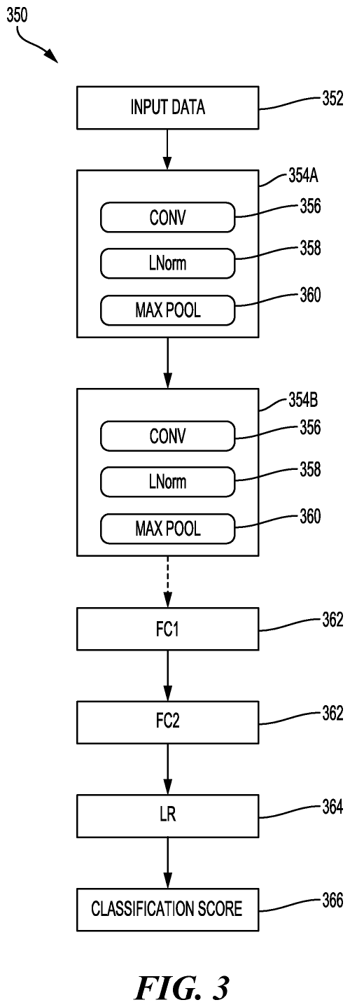

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

Aspects of the present disclosure are directed to knowledge distillation with search and reconfiguration of a student network for learning knowledge from a small teacher model. In some aspects, an improved or even optimal student model architecture may be determined by minimizing the accuracy loss and the number of trainable parameters. Additionally, in some aspects, model compression techniques such as quantization and pruning, for example, may be applied to further improve the student model architecture.

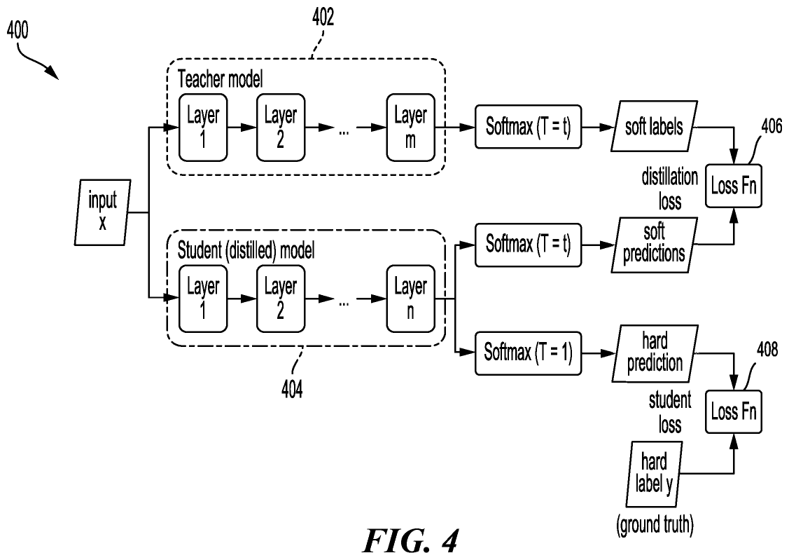

FIG. 4 is a block diagram illustrating an example architecture 400 for kernel guided student architecture search and reconfiguration, in accordance with aspects of the present disclosure. Referring to FIG. 4, the example architecture 400 includes a teacher model 402 having m layers and a student model 404 that has n layers, where m>>n. By way of example only, the teacher model 402 may include 100 layers with one million parameters and the student model 404 may include 10 layers with 10,000 parameters. In accordance with aspects of the present disclosure, knowledge distillation techniques may be applied such that the teacher model 402 may train the smaller student model 404 to serve as a compressed version of the teacher model 402. The teacher model 402 is pre-trained based on the hard labels (ground truth) y.

The student model 404 may be configured based on a guided architecture search. In the guided architecture search, layers of the teacher model 402 may be identified. For example, the teacher model 402 may be parsed to identify a type of each layer (e.g., a dense layer, a convolutional layer, a max pooling, and/or an activation layer) in the model. In one example, a first layer of the teacher model 402 may be determined to be a dense layer. In another example, the first layer of the teacher model 402 may be determined to be a convolutional layer.

The student model 404 replicates the initial layer of the teacher model 402. For instance, if layer 1 of the teacher model 402 is a dense layer, the architecture of the student model 404 may likewise have a dense layer as layer 1. On the other hand, if layer 1 of the teacher model 402 is a convolutional layer, then the architecture of the student model 404 may have a convolutional layer as layer 1.

The guided architecture search may also iteratively search the teacher model 402 for and remove homogenous layers. That is, layers having the same layer type may be identified. The second instance of the same layer type of the teacher model 402 may be removed. For example, if the teacher model 402 includes a layer 1 and layer 2 that are both convolutional layers, the student model 404 may be configured with the layer 2 convolutional layer removed.

Hyper parameters may be selected for the student model 404. The student model 404 may be trained and tested. The teacher model 402 and the student model 404 may each receive the same input x. The input x may be separately processed via the layers of the respective models. For example, after a first iteration, the teacher model 402 may include m layers, and the student model 404 may include n layers, where n=m−1 (e.g., the teacher model 402 architecture with the consecutive homogenous layer removed). The output of the teacher model 402 is temperature scaled (divided by T=t) via a softmax output layer to produce soft labels. Soft labels may essentially relax the class definitions making it easier to match than ground truth labels. The soft label may be a mean (e.g., arithmetic or geometric) of the predictive distribution.

On the other hand, the student model 404 processes the input x, and provides an output that is temperature scaled (e.g., divided by T=t as adjusted in the distillation) to produce soft predictions (classification of the input x). The soft prediction is compared with the soft labels to compute a distillation loss 406.

In addition, the student model 404 outputs a hard prediction (e.g., without temperature scaling (e.g., divided by T=1). The hard prediction is compared with the hard (ground truth) labels y to compute a student loss 408. Accordingly, the resulting total loss function L as a function of the distillation loss 406 and the student loss 408 is given by:

$$L ( x ; W ) = α * H ( y , σ ( {z}_{s} ; T = 1 ) ) + β * H ( σ ( {z}_{t} ; T = t ) , σ ( {z}_{s} ; T = t ) ) , \qquad ( 1 )$$

where x is the input, W are the student model parameters, y is the ground truth label, H is the cross-entropy loss function, α is the softmax function parameterized by the temperature T and α and β are coefficients that may be selected based on a tradeoff between accuracy and memory consumption. The parameters zₛ and zₜ are the logits of the student model 404 and the teacher model 402, respectively.

Optimization techniques may be applied to determine parameters of the student model 404 to reduce the model loss L. The optimizations may be interleaved with layer removals or after removal of a layer is completed.

The iterative process may be repeated to search for and remove additional layers of the same type. Thereafter, the student model hyper parameters may be selected and the student model may be retrained and tested. The iterative process may be repeated to determine architecture and parameters of the student model 404 that satisfy model design objectives. In some aspects, architecture and parameters of the student model 404 may be determined for improved efficiency and reduced energy consumption.

Example pseudocode for the guided search and knowledge distillation according to aspects of the present disclosure are provided in the listing below:

Guided Search and Knowledge Distillation Process

| | |
|---|---|
| 1. | Input (teacher network, dataset), output (student network) |
| 2. | Parse teacher network |
| 3. | Preserve first layer |
| 4. | Iteratively remove consecutive homogeneous(same type) layers, |
| | train, test: |
| | Remove next one consecutive intermediate layer (for |
| | example with same/homogeneous type: convolution) |
| | Architecture-search re-configure first layer |
| | hyper parameters (filters number, kernel |
| | size, etc.) |
| | Auto-search hyper parameters for student |
| | model (T/α/β) |
| | Train and measure cost metric (accuracy, |
| | trainable parameters) |
| | If design objectives (e.g., size or accuracy) |
| | satisfied, go to 5, otherwise go to 4 |
| 5. | Output optimal student network |

In some aspects, additional model compression techniques may be applied to further improve the student model 404. For example, parameters of the student model 404 may be quantized, pruned or both.

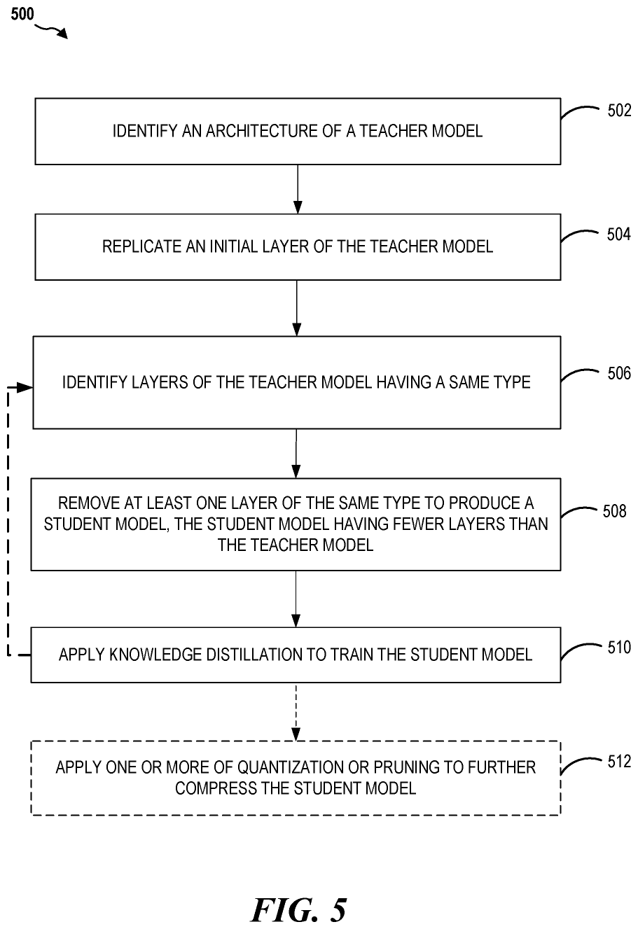

FIG. 5 is a flow diagram illustrating a method 500 for compressing an artificial neural network, in accordance with aspects of the present disclosure. At block 502, an architecture of a teacher model is identified. For example, as described with reference to FIG. 4, the teacher model 402 may be parsed to identify a type of each layer (e.g., a dense layer, a convolutional layer, a max pooling, and/or an activation layer) in the model.

At block 504, an initial layer of the teacher model is replicated. That is, a student model may be configured with the same initial layer as the initial layer of the teacher model. For example, if the teacher model has an initial layer that is a dense layer, the student model may be configured with a dense layer as an initial layer.

At block 506, layers of the teacher model having a same type are identified. At block 508, one or more the layers of the same type is removed to produce a student model. The student model has fewer layers than the teacher model. Furthermore, at block 510, knowledge distillation is applied to train the student model. The method may return to block 506 to iteratively identify and remove additional successive layers of the same type and further compress (e.g., reduce layers) the student model.

At block 512, the process may optionally apply one or more of quantization or pruning to further compress (e.g., reduce parameters) the student model.

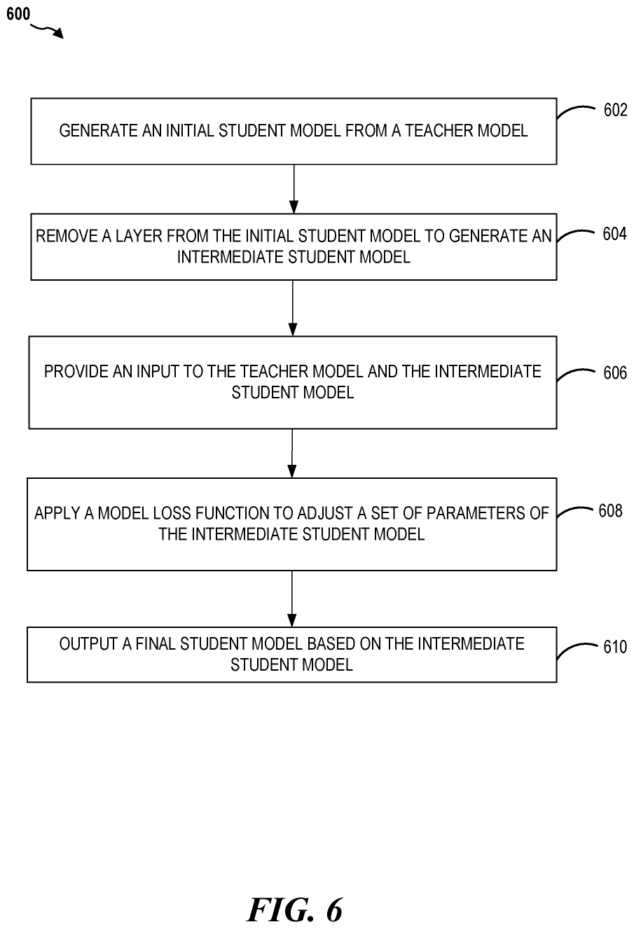

FIG. 6 is a flow diagram illustrating a method 600 for compressing an artificial neural network, in accordance with aspects of the present disclosure. At block 602, the method 600 generates an initial student model from a teacher model. For example, as discussed with reference to FIG. 4, a student model 404 replicates the initial layer of the teacher model 402. For instance, if layer 1 of the teacher model 402 is a dense layer, the architecture of the student model 404 may likewise have a dense layer as layer 1

At block 604, the method 600 removes a layer from the initial student model to generate an intermediate student model. For instance, referring to FIG. 4, a guided architecture search may also iteratively search the teacher model 402 for and remove homogenous layers. That is, layers having the same layer type may be identified. The second instance of the same layer type of the teacher model 402 may be removed. For example, if the teacher model 402 includes a layer 1 and layer 2 that are both convolutional layers, the student model 404 may be configured with the layer 2 convolutional layer removed.

At block 606, the method 600 provides an input to the teacher model and the intermediate student model. For example, as shown in FIG. 4, the teacher model 402 and the student model 404 may each receive the same input x.

At block 608, the method 600 applies a model loss function to adjust a set of parameters of the intermediate student model. As discussed in FIG. 4, the input x may be separately processed via the layers of the respective models. For example, after a first iteration, the teacher model 402 may include m layers, and the student model 404 may include n layers, where n=m−1 (e.g., the teacher model 402 architecture with the consecutive homogenous layer removed). The output of the teacher model 402 is temperature scaled (divided by T=t) via a softmax output layer to produce soft labels. Soft labels may essentially relax the class definitions making it easier to match than ground truth labels. The soft label may be a mean (e.g., arithmetic or geometric) of the predictive distribution.

On the other hand, the student model 404 processes the input x, and provides an output that is temperature scaled (e.g., divided by T=t as adjusted in the distillation) to produce soft predictions (classification of the input x). The soft prediction is compared with the soft labels to compute a distillation loss 406.

At block 610, the method 600 outputs a final student model based on the intermediate student model. Referring to FIG. 4, an iterative process may be repeated to determine architecture and parameters of the student model 404 that satisfy model design objectives. Thereafter the student model may be output.

In an aspect, the identifying means, the replicating means, layer identifying means, removing means and/or the applying means may be the CPU 102, program memory associated with the CPU 102, the dedicated memory block 118, fully connected layers 362, and/or the routing connection processing unit 216 configured to perform the functions recited. In another configuration, the aforementioned means may be any module or any apparatus configured to perform the functions recited by the aforementioned means.

In an aspect, the generating means, the removing means, providing means, applying means and/or the outputting means may be the CPU 102, program memory associated with the CPU 102, the dedicated memory block 118, fully connected layers 362, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

Implementation examples are provided in the following numbered clauses:

1. A method comprising:
generating an initial student model from a teacher model;
removing a layer from the initial student model to generate an intermediate student model;
providing an input to the teacher model and the intermediate student model;
applying a model loss function to adjust a set of parameters of the intermediate student model; and
outputting a final student model based on the intermediate student model.

2. The method of clause 1, further comprising operating the final student model to generate an output based on the input.

3. The method of clause 1 or 2, in which the layer removed from the initial student model has a same type as a preceding layer of the initial student model.

4. The method of clause 1 or 2 or 3, further comprising training the final student model based on a minimization of a cross entropy loss function between the teacher model and the intermediate student model.

5. The method of any of clauses 1-4, further comprising applying one or more of quantization or pruning to the final student model.

6. The method of any of clauses 1-5, further comprising setting a hyper parameter of the final student model to control a tradeoff between a model accuracy and a memory consumption.

7. An apparatus comprising:
a memory; and
at least one processor coupled to the memory, the at least one processor being configured:
to generate an initial student model from a teacher model;
to remove a layer from the initial student model to generate an intermediate student model;
to provide an input to the teacher model and the intermediate student model;
to apply a model loss function to adjust a set of parameters of the intermediate student model; and
to output a final student model based on the intermediate student model.

8. The apparatus of clause 7, in which the at least one processor being further configured to operate the final student model to generate an output based on the input.

9. The apparatus of clause 7 or 8, in which the layer removed from the initial student model has a same type as a preceding layer of the initial student model.

10. The apparatus of clause 7 or 8 or 9, in which the at least one processor being further configured to train the final student model based on a minimization of a cross entropy loss function between the teacher model and the intermediate student model.

11. The apparatus of any of clauses 7-10, in which the at least one processor being further configured to apply one or more of quantization or pruning to the final student model.

12. The apparatus of any of clauses 7-11, in which the at least one processor being further configured to set a hyper parameter of the final student model to control a tradeoff between a model accuracy and a memory consumption.

13. An apparatus comprising:
means for generating an initial student model from a teacher model;
means for removing a layer from the initial student model to generate an intermediate student model;
means for providing an input to the teacher model and the intermediate student model;
means for applying a model loss function to adjust a set of parameters of the intermediate student model; and
means for outputting a final student model based on the intermediate student model.

14. The apparatus of clause 13, further comprising means for operating the final student model to generate an output based on the input.

15. The apparatus of clause 13 or 14, in which the layer removed from the initial student model has a same type as a preceding layer of the initial student model.

16. The apparatus of any of clauses 13-15, further comprising means for training the final student model based on a minimization of a cross entropy loss function between the teacher model and the intermediate student model.

17. The apparatus of any of clauses 13-16, further comprising means for applying one or more of quantization or pruning to the final student model.

18. The apparatus of any of clauses 13-17, further comprising means for setting a hyper parameter of the final student model to control a tradeoff between a model accuracy and a memory consumption.

19. A non-transitory computer readable medium having encoded thereon program code, the program code being executed by a processor and comprising:
program code to generate an initial student model from a teacher model;
program code to remove a layer from the initial student model to generate an intermediate student model;
program code to provide an input to the teacher model and the intermediate student model;
program code to apply a model loss function to adjust a set of parameters of the intermediate student model; and
program code to output a final student model based on the intermediate student model.

20. The non-transitory computer readable medium of clause 19, further comprising program code to operate the final student model to generate an output based on the input.

21. The non-transitory computer readable medium of clause 19 or 20, in which the layer removed from the initial student model has a same type as a preceding layer of the initial student model.

22. The non-transitory computer readable medium of any of clauses 19-21, in which the at least one processor being further configured to train the final student model based on a minimization of a cross entropy loss function between the teacher model and the intermediate student model.

23. The non-transitory computer readable medium of any of clauses 19-22, further comprising program code to apply one or more of quantization or pruning to the final student model.

24. The non-transitory computer readable medium of any of clauses 19-23, further comprising program code to set a hyper parameter of the final student model to control a tradeoff between a model accuracy and a memory consumption.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (TR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method comprising:
generating an initial student model from a teacher model;
removing a layer from the initial student model to generate an intermediate student model;
providing an input to the teacher model and the intermediate student model;
applying a model loss function to adjust a set of parameters of the intermediate student model; and
outputting a final student model based on the intermediate student model.

2. The method of claim 1, further comprising operating the final student model to generate an output based on the input.

3. The method of claim 1, in which the layer removed from the initial student model has a same type as a preceding layer of the initial student model.

4. The method of claim 1, further comprising training the final student model based on a minimization of a cross entropy loss function between the teacher model and the intermediate student model.

5. The method of claim 1, further comprising applying one or more of quantization or pruning to the final student model.

6. The method of claim 1, further comprising setting a hyper parameter of the final student model to control a tradeoff between a model accuracy and a memory consumption.

7. An apparatus comprising:
a memory; and
at least one processor coupled to the memory, the at least one processor being configured:
to generate an initial student model from a teacher model;
to remove a layer from the initial student model to generate an intermediate student model;
to provide an input to the teacher model and the intermediate student model;
to apply a model loss function to adjust a set of parameters of the intermediate student model; and
to output a final student model based on the intermediate student model.

8. The apparatus of claim 7, in which the at least one processor being further configured to operate the final student model to generate an output based on the input.

9. The apparatus of claim 7, in which the layer removed from the initial student model has a same type as a preceding layer of the initial student model.

10. The apparatus of claim 7, in which the at least one processor being further configured to train the final student model based on a minimization of a cross entropy loss function between the teacher model and the intermediate student model.

11. The apparatus of claim 7, in which the at least one processor being further configured to apply one or more of quantization or pruning to the final student model.

12. The apparatus of claim 7, in which the at least one processor being further configured to set a hyper parameter of the final student model to control a tradeoff between a model accuracy and a memory consumption.

13. An apparatus comprising:
means for generating an initial student model from a teacher model;
means for removing a layer from the initial student model to generate an intermediate student model;
means for providing an input to the teacher model and the intermediate student model;
means for applying a model loss function to adjust a set of parameters of the intermediate student model; and
means for outputting a final student model based on the intermediate student model.

14. The apparatus of claim 13, further comprising means for operating the final student model to generate an output based on the input.

15. The apparatus of claim 13, in which the layer removed from the initial student model has a same type as a preceding layer of the initial student model.

16. The apparatus of claim 13, further comprising means for training the final student model based on a minimization of a cross entropy loss function between the teacher model and the intermediate student model.

17. The apparatus of claim 13, further comprising means for applying one or more of quantization or pruning to the final student model.

18. The apparatus of claim 13, further comprising means for setting a hyper parameter of the final student model to control a tradeoff between a model accuracy and a memory consumption.

19. A non-transitory computer readable medium having encoded thereon program code, the program code being executed by a processor and comprising:
program code to generate an initial student model from a teacher model;
program code to remove a layer from the initial student model to generate an intermediate student model;
program code to provide an input to the teacher model and the intermediate student model;
program code to apply a model loss function to adjust a set of parameters of the intermediate student model; and
program code to output a final student model based on the intermediate student model.

20. The non-transitory computer readable medium of claim 19, further comprising program code to operate the final student model to generate an output based on the input.

21. The non-transitory computer readable medium of claim 19, in which the layer removed from the initial student model has a same type as a preceding layer of the initial student model.

22. The non-transitory computer readable medium of claim 19, in which the at least one processor being further configured to train the final student model based on a minimization of a cross entropy loss function between the teacher model and the intermediate student model.

23. The non-transitory computer readable medium of claim 19, further comprising program code to apply one or more of quantization or pruning to the final student model.

24. The non-transitory computer readable medium of claim 19, further comprising program code to set a hyper parameter of the final student model to control a tradeoff between a model accuracy and a memory consumption.
